(19) United States
(12) Patent Application Publication
(10) Pub. No.: US 2006/0236353 A1
(43) Pub. Date: Oct. 19, 2006

(54) Method and system for buffered digital entertainment

(76) Inventors: Chun Yen Cheng, Ottawa (CA); Jiangtao Wen, Temple City, CA (US); Michael J. Rider, Ottawa (CA); Stanley T. Chow, Ottawa (CA)

Correspondence Address: HAYES, SOLOWAY P.C., 3450 E. SUNRISE DRIVE, SUITE 140, TUCSON, AZ, 85718, US

(21) Appl. No.: 11/222,905

(22) Filed: Sep. 9, 2005

(30) Foreign Application Priority Data
Apr. 18, 2005 (CA) 2,504,556

(51) Int. Cl. H04N 7/173

(52) U.S. Cl. 725/90; 725/89; 725/102

(57) ABSTRACT

The present invention relates generally to multimedia, and more specifically, to a system and method of improved television viewing using automatic parallel recording of television channels. The invention continuously captures and records multimedia content for a set of “channels” in a central location, buffering all available channels for a number of days or weeks on a continuous basis. The buffered programming may then be streamed over a network such as the Internet on request, to the viewer's premises where it can be viewed on request via an appropriate display device such as a television equipped with an IP-enabled set top box or on a personal computer.

This application claims priority from Canadian Patent Application Serial No. 2,504,556 filed on Apr. 18, 2005, which is incorporated herein by reference.

### FIELD OF INVENTION

The present invention relates generally to multimedia, and more specifically, to a system and method of improved television viewing using automatic parallel recording of television channels.

### BACKGROUND OF THE INVENTION

The introduction of digital compression, digital satellite, cable and high speed network transmission has resulted in the proliferation of television channels and digital content available to the average consumer. This has resulted in two major trends

Firstly, this makes it difficult for the viewer to track what is being shown on different channels and/or from different content providers. In an attempt to manage the volume of content available, a number of electronic program guide (EPG) and digital content searching products and services have been introduced. Many of these products support user profiling functions which reduce the amount of information that is presented to the viewer at each given time. In spite of these capabilities, the average viewer is still unable to keep track of the diversity of content available or been delivered. In addition, due to the mobile nature of many emerging applications and the unreliability of mobile transmission channels, reception of digital content may not be available at all times (for example, when an automobile with a satellite audio receiver is inside a tunnel). This lowers the quality of the viewer experience.

Secondly, the increasingly frantic pace of life and the great variety of possible sources of information, communication and entertainment such as the Internet, has resulted in a progressively shorter interest span of a modern connected viewer.

The above two trends make “channel surfing” more and more frequent as the way viewers watch television changes. Channel surfing is defined as television (transmitted over the air, or via cable, satellite, or IP networks) viewers randomly iterating through available TV channels until they find some show they want to watch, rather than relying solely on EPG or printed/online broadcast schedules. However, channel surfing is a disruptive experience due to the unending context setting and decision making needed for each channel and, in a universe with more than 100 channels available, the channel surfing viewer will inevitably miss the beginning of desired programs.

In an attempt to deal with the availability of content at an inconvenient time, viewers have employed VCRs (video cassette recorders) and PVRs (personal video recorders) to record programs, so they can be viewed later. But such devices have proven to be frustrating, troublesome devices; they can be difficult to program, run out of tape or disk space, fail at unpredictable times and all too frequently, and they operate at the mercy of local electrical power utilities. Having such a hardware device in the home is simply another complicated electronic device that has to be purchased, maintained and protected from power surges and other electric supply issues.

VCRs and PVRs have to be programmed ahead of time to record a precise channel during a precise period of time. Many shows also run longer than what is expected or published—if a show runs too long, the end of the show which is typically the climax or the denouement, is not recorded by the device. This most often happens with live broadcasts such as sports or breaking news. Of course, if the viewer forgets to program the VCR or PVR, or programs it incorrectly, the show is lost altogether.

PVRs offer advantages over older VCRs, but also present new problems. For example, PVRs normally require metadata in the forms of EPG or similar data to program the recording. If there is any error in the EPG, the PVR will not record the required material.

Super-PVRs are simply PVRs that can record multiple channels simultaneously. These devices have the same problems as existing PVRs plus the additional costs associated with purchasing, protecting, powering and cooling of a more expensive device.

New devices and services such as TiVo and ReplayTV utilize digital compression technology in conjunction with high volume, random access storage such as hard disks, EPG information, personalization and user profiling mechanisms to provide functionalities such as tracing user preference, and traditional video cassette recorder functions such as pause, replay, and fast forward. These new devices also provide functionality which was not available with VCRs, such as automatic “guessing” and recording of programs of interest to the viewer, classification and organization of programs recorded on the hard drive into personalized classes. The “Personal Channels” in U.S. Pat. No. 6,324,338, as well as the “tricky” viewing modes of live television (e.g., Live Pause, Instant Replay, etc.) are examples of these.

Although the above technologies and devices do provide interesting and valuable functionality for some viewers they fail to address the problems outlined above, and in particular, they do nothing to enhance the TV watching experience for the channel surfers.

Therefore, there is a need for improved method and system for distributing and providing access to digital content which addresses the problems outlined above. This design must also be provided with consideration for reliability, cost and ease of implementation.

### SUMMARY OF THE INVENTION

It is an object of the invention to provide an improved method and system for distributing and providing access to digital content, which obviates or mitigates at least one of the disadvantages of the prior art.

The invention is designed to deliver television programming functionality that is particularly beneficial for channel surfers and casual TV viewers. It allows a viewer to access any digital content “channel” at any point in a program, to skip back to the point where the show was last viewed or to watch a show on any channel at some later point in a preset time period. The principal value of the invention is to tailor content consumption to the viewer's timetable rather than obliging the casual viewer to adapt his lifestyle to the multimedia service provider's delivery schedule.

The invention continuously captures and records content for a set of “channels” in a central location. The term “channels” used in this application refers to both the traditional concept of television channels and any serialized media delivery format that are usually associated with a physical characteristic (e.g. a specific spectrum frequency during transmission), as well as virtual channels for IP-based television which is a temporally concatenation of data streams. Ideally, the invention will buffer all available channels for a number of days or weeks on a continuous basis. The buffered programming may then be streamed over a network such as the Internet on request, to the viewer's premises where it can be viewed on request via an appropriate display device such as a television equipped with an IP-enabled set top box or on a personal computer.

The viewer is able to select and watch a desired channel either in real-time fashion as they do with broadcast television, or skip back to any time index for which the invention has buffered recorded programming. Each channel is buffered for a configurable number of days to allow viewers to watch any programs on a selected channel at any time within the buffered period.

According to the present invention there is provided a method for improving multimedia programming comprising steps of: continuously capturing content data from a plurality of serialized multimedia sources in a central location; compressing and storing the captured content data in at least one cache in a central location; allowing a remote viewer to make selections with regard to the content and the manner in which the compressed and stored content data is to be transmitted to the viewer, including time and location; validating and authorizing viewer access, channel and time indexing selection; and delivering the selected content data to the viewer, over a bi-directional data network of appropriate bandwidth.

According to an additional embodiment of the invention there is provided a system for improving television viewing comprising: a media capture subsystem for continuously capturing content data from a plurality of serialized multimedia sources; a subsystem for compressing and storing the captured content data in at least one central cache; a subsystem allowing a remote viewer to make selections with regard to the content and the manner in which the compressed and stored content data is to be transmitted to the viewer, including time and location; a multimedia delivery subsystem for delivering the selected content data to the viewer, over a bi-directional data network of appropriate bandwidth; and a management sub-system for viewer validation, service verification, channel and time indexing selection, and system maintenance and administration functionality.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 presents a block diagram of a buffered digital entertainment system, in accordance with an embodiment of the present invention;

FIG. 2 presents a graphical representation of the end user control system in accordance with an embodiment of the present invention;

FIG. 3 presents a flowchart of an exemplary method of buffered media delivery, in accordance with an embodiment of the present invention;

FIG. 4 presents a flowchart of an exemplary embodiment of the media capture subsystem, in accordance with an embodiment of the present invention;

FIG. 5 presents a flowchart of an exemplary method of processing multimedia sources, in accordance with an embodiment of the present invention;

FIG. 6 presents a flowchart of an exemplary method of media storage, in accordance with an embodiment of the present invention;

FIG. 7 presents a flowchart of an exemplary method of delivering media to the viewer, in accordance with an embodiment of the present invention; and

FIG. 8 presents an exemplary time index to permit fast traversal of captured media without the visible blocky video artifacts due to resynchronize required for traditional digital television sources. The example is shown with reference frames being generated once every second and change frames being generated between the reference frames.

### DETAILED DESCRIPTION

An exemplary system and method which addresses the above requirements, is described hereinafter. This system and method improves the television viewer's experience during an activity generally referred to as “channel surfing” while watching broadcast television. It also eliminates the complexity of programming and maintaining traditional VCRs and PVRs. Other advantages are described hereinafter and/or are generally clear from the description which follows.

As described above, the process of channel surfing currently presents a discontinuous experience as the viewer accesses arbitrary points of broadcasted shows when switching channel at points other than the beginning of a show. Embodiments of the invention enhance the viewing experience for a broad range of viewers, and tackle the unique challenges viewers face in the emerging television and other multimedia entertainment marketplace.

In short, embodiments of the invention centrally and continuously record and store the content broadcast on multiple TV channels or available from any other desired programming source(s), caching the content in a central location for as long as required. The recorded content is delivered to the remote viewer on demand. A novel user interface is also provided, that permits the viewer to simply navigate through the recorded material.

Furthermore, embodiments of the invention separate the channel selection process from the intra-channel selection process. Channel selection is often subjected to various restrictions such as subscription package, parental supervision, time-based access and so forth. Embodiments of the invention include a policy engine to provide functionality to enable such restrictions.

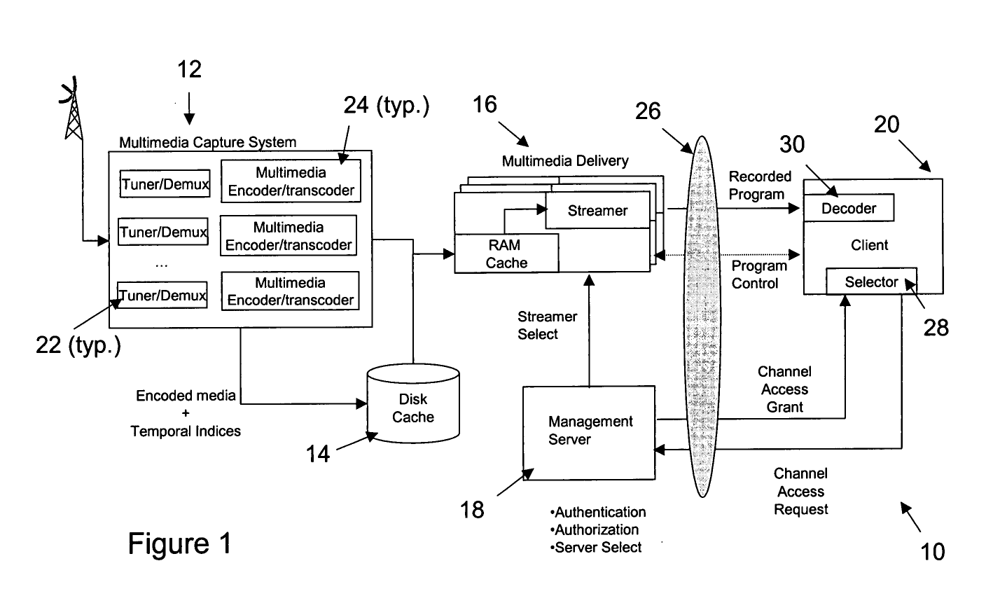

FIG. 1 presents an overview of an exemplary system 10 of the invention. The centralized components of the system 10 include a multimedia capture subsystem 12, a multimedia storage subsystem 14, a multimedia delivery subsystem 16, and a management server 18. These centralized components provide content to various clients 20 through communication network 26, though only one such client 20 is shown in FIG. 1.

The multimedia capture subsystem 12 consists of an array of tuners and/or demultiplexers 22 supporting a variety of media for the purpose of capturing individual channels, and an array of audio and video encoders, and/or transcoders, rate shapers, and multimedia demultiplexers 24. In cooperation with the multimedia storage subsystem 14, these multimedia encoders 24 enable all captured channels to be encoded, transcoded and/or compressed, then buffered and stored. Data content is preferably compressed to save storage space and bandwidth, but this is not essential. Of course, complementary decompression would be required at the Client 20. Many video compression techniques are available which reduce the demand on bandwidth by a great deal, including MPEG-4 Part 2 and MPEG-4 Part 10. Other compression techniques and standards will inevitably be developed, but these are easily applied to the invention.

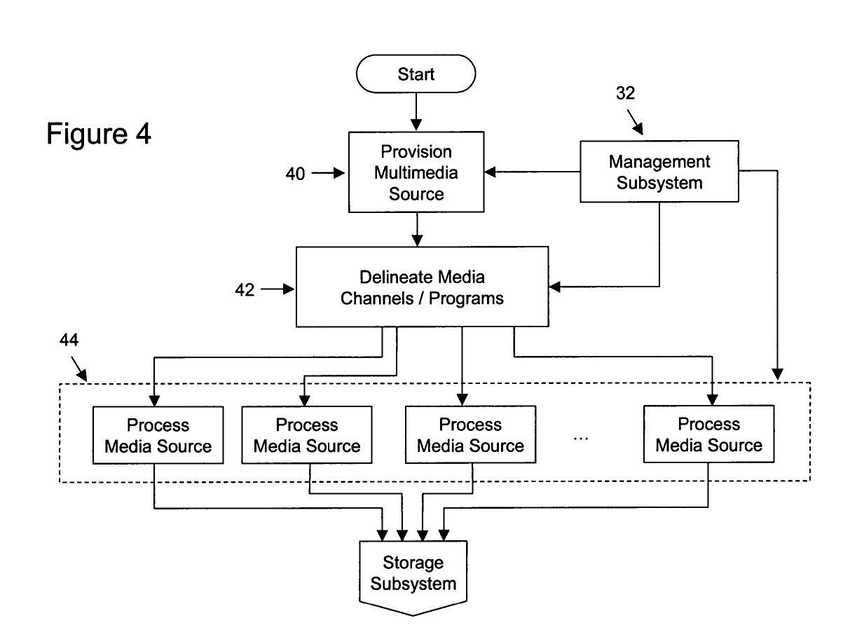

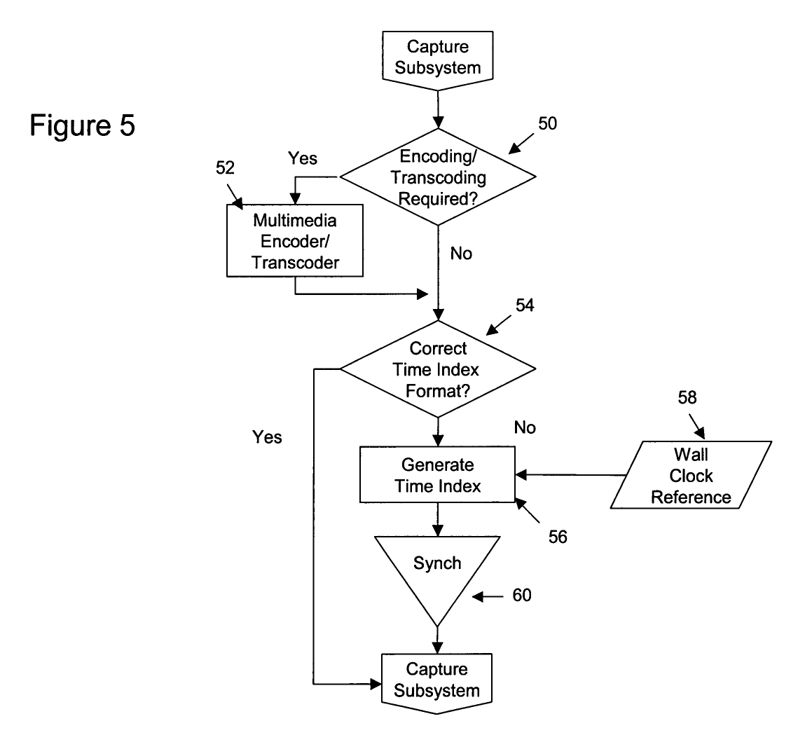

Note that in some applications, the multimedia demultiplexers 24 may simply act as a “pass-through” of an already packaged show. The operation of the multimedia capture subsystem 12 is described in greater detail with respect to FIG. 4, while the multimedia demultiplexers 24 are described in greater detail with respect to FIG. 5.

The multimedia capture subsystem 12 acquires a plurality of serialized multimedia programming including television channels from a variety of media sources such as cable, satellite, over-the-air broadcast, the Internet or any other appropriate delivery mechanism. After suitable processing such as clock time indexing and encoding or transcoding, the processed multimedia programming is delivered to the multimedia delivery subsystem 16.

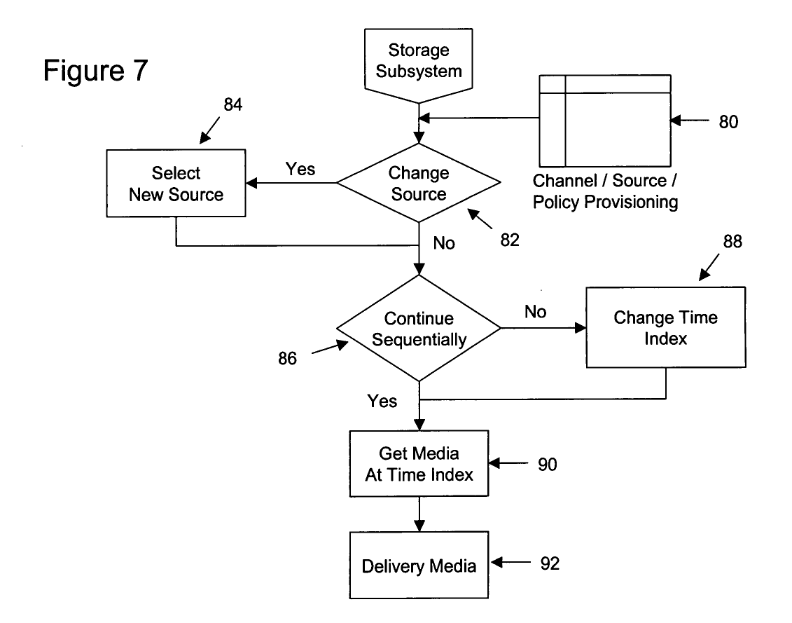

The multimedia delivery subsystem 16 (or “streamer”) is operable to provide real time delivery of the required number of media streams to the Client 20 over a communication network 26 such as the Internet. The multimedia delivery subsystem 16 will deliver the requested streams starting at the selected time index to the individual viewer. The multimedia delivery subsystem 16 is described in greater detail with respect to FIG. 7.

Functionality on the Client 20 typically includes an access system 28 (or “selector”) enabling the viewer to select desired shows and/or location/mode/time for the content consumption. Channel access requests are transmitted to the managemenet server 18, and responses such as channel access grant notices, are received as shown in FIG. 7. The Client 20 also includes a multimedia decoder 30 (“decoder”) in the viewer premises instantiated in a set top box, television, personal computer or other device (for example, a personal digital assistant or PDA, or a cellular telephone) to decode the stream delivered over the communication network 26 and render the decoded output for presentation. The decoder 30 in the viewer premises may have local storage, though it is not essential. The decoder 30 and the selector 28 will generally reside in the same physical device and/or at the same geographical location.

The management server 18 communicates with the Client 20, having functionality to perform such tasks as client validation, service verification, channel and time indexing selection, and system maintenance and administration functionality.

Exemplary descriptions of the various components of the system are presented hereinafter, but of course, it would be clear to a person skilled in the art that the invention could be implemented in many different ways.

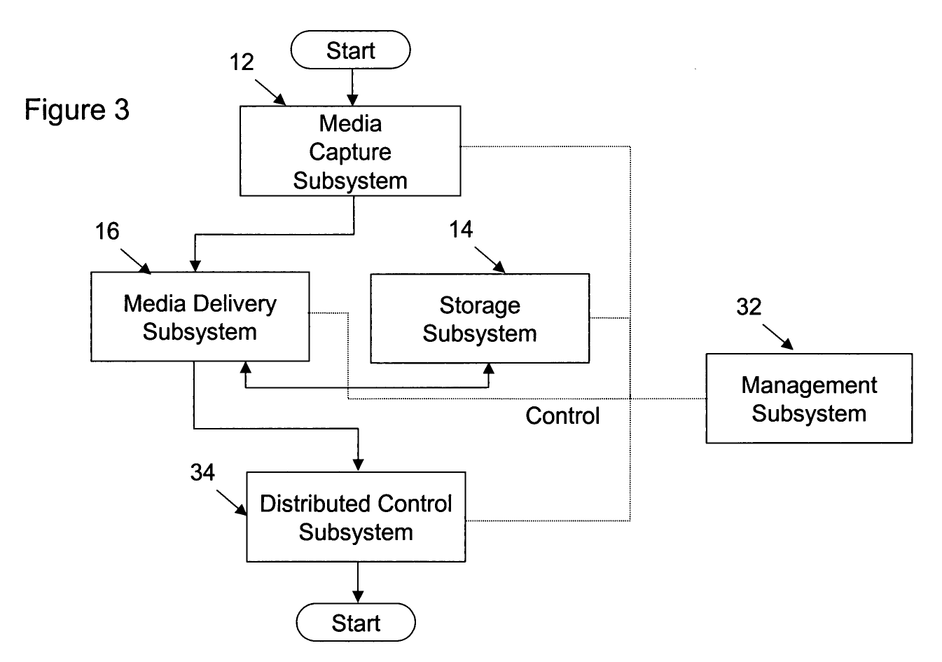

FIG. 3 presents a simplified block diagram of the system of the invention, mainly to introduce the management subsystem 32 and the distributed control system 34.

The management subsystem 32 of FIG. 3 provides overall control and policy management for the whole system. In general, it controls:
1) which serialized multimedia programming is captured and processed by the multimedia capture subsystem,
2) which multimedia delivery subsystem will cache each processed multimedia source, and
3) which multimedia delivery subsystem will handle each client request.
   This simplifies the multimedia delivery subsystem 16 by localizing any policy related issues to the management subsystem 32 and allowing the media delivery subsystem to focus solely on delivering multimedia material to the viewer and any viewer request for temporal movement within a channel. In addition, it controls all client “channel” access requests with respect to authentication, authorization, subscriber specified policy enforcement and multimedia delivery subsystem selection. Finally, it also performs system configuration, maintenance and fault detection, containment and recovery functions.

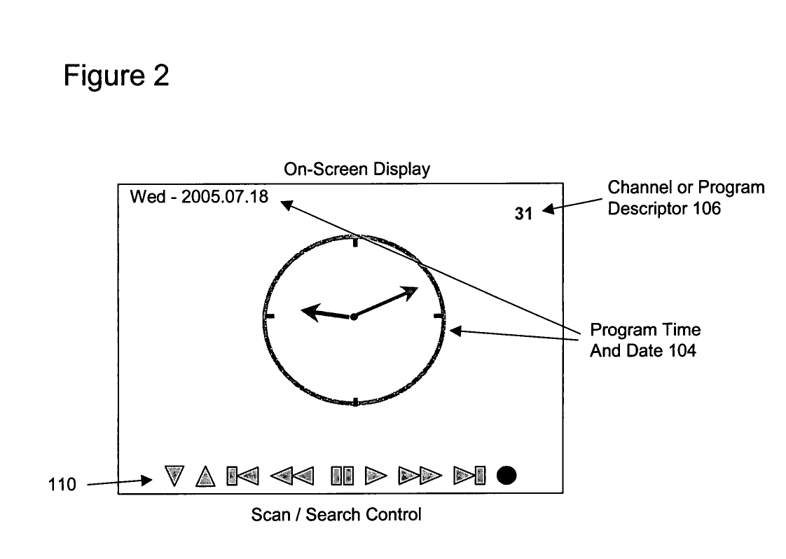

The distributed control system 34 resides on both the management server 18 and the Client 20. It permits the viewer to intuitively and rapidly move through the cached multimedia programming by considering the time indices for the recorded material and the intuitive clock-based user interface available to the viewer as shown in FIG. 2.

Other interfaces could be used, or features of this interface modified, but it is preferable that the following features be included as shown in FIG. 2:
a time and date index 104 for the current position in the current show;
the channel 106 for the current show; and
a standard set of remote control functions 110 embodied in a physical or virtual remote control.

The time and date index 104 for the current show is displayed on the viewing terminal as time on an analog or digital clock representation, and a date representation. When the viewer elects to change the current time index, by moving back and forth in the current viewed recorded material using the standard set of remote control functions 110, the time index changes will be reflected on the display with the playback of the recorded multimedia programming at the requested time index and the clock display will be updated to reflect the new time index.

When the viewer activates any of the controls 110 to change either the source (change “channel”) or the current temporal location (jump to different time index) in the same source, the distributed control system 34 will send the new requested time index to the multimedia delivery subsystem 16. The multimedia delivery subsystem 16 will locate the multimedia programming associated with the request time index in the storage subsystem 14 and send that down to the viewer's display terminal 20.

If recorded multimedia programming associated with the requested time index is no longer available from the multimedia storage subsystem 14 because the recorded multimedia programming has expired and been removed, the multimedia delivery subsystem 34 will send the time index and programming associated with the oldest available recorded multimedia programming for that “channel”.

In case of a channel change request, the distributed control subsystem 34 will send the request for the new channel to the management subsystem 32 where the authentication/authorization and any policy checking will be performed. Assuming the new channel request is accepted, the management subsystem 32 will send back to the distributed control system 34, the specific multimedia delivery subsystem 16 to be contacted to request the recorded multimedia material for the requested channel.

FIG. 4 presents a more detailed flow diagram of the multimedia capture subsystem 12. As noted above, this subsystem acquires data content from a variety of media sources. The management subsystem 32 controls the multimedia source selection 40 of the multimedia capture subsystem 12, each selected serialized multimedia source being assigned to one or more multimedia processing modules 42. This permits the multimedia sources to be processed in parallel and in real time 44.

In each multimedia processing module 24, as shown in FIG. 5, the determination is first made as to whether the multimedia programming is to be encoded or transcoded 50. Analogue data streams, for example, will have to be encoded into digital form at step 52, and various digital streams may have to be transcoded into a format used by a given implementation of the invention.

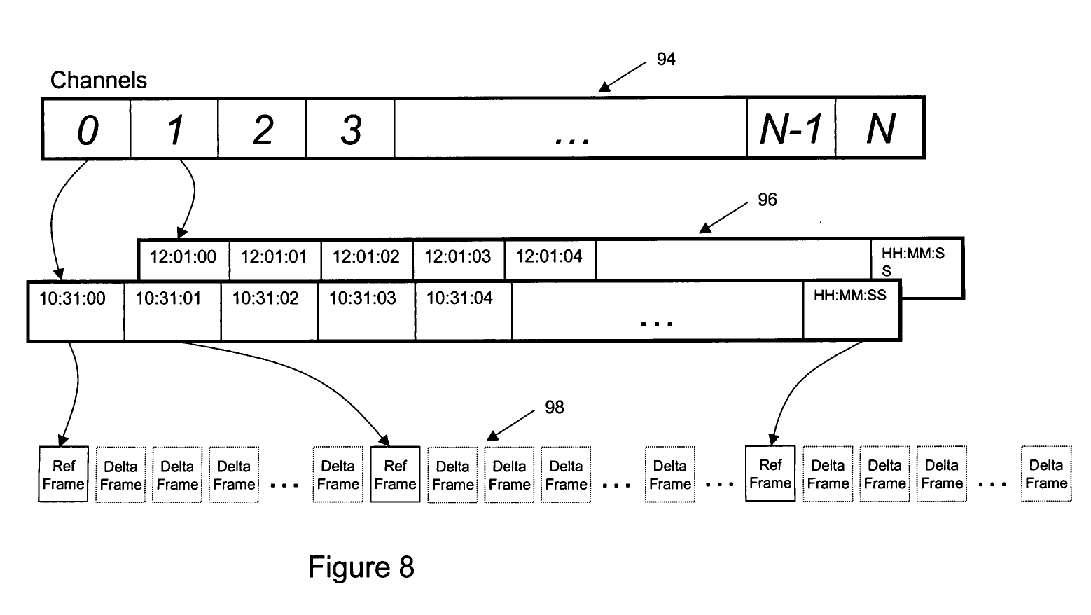

The determination is then made at step 54 as to whether the processed multimedia programming is to be synchronized with a generated wall clock time index, as shown in FIG. 8. The generation of a time index 56 requires access to the wall clock reference 58 and synchronization with the data stream 60. The time indices comprise a reference frame associated with a modern video processing algorithm such as H.264.

The time indices, which may be discontiguous, point to the location in the multimedia stream where reference frames (audio or video) are created by the encoder. The discontiguity capability of the time indices accommodates gaps in the multimedia source transmission schedule. This permits the delivery subsystem to almost instantaneously locate a reference frame at the required time index provided by the distributed control subsystem 34 without the need for several seconds of resynchronization as is required for existing digital broadcast television systems.

Referring to FIG. 8, content data for a plurality of channels will typically be multiplexed in time as shown in time bar 94. Each block of data content will be indexed in time. Time bar 96 shows the data content in blocks of one second, though other time increments could be also be used. Each block is typically broken down into a reference frame and multiple data content frames, the nature of the data content frames being dictated by the method of encoding and transmission (see time bar 98).

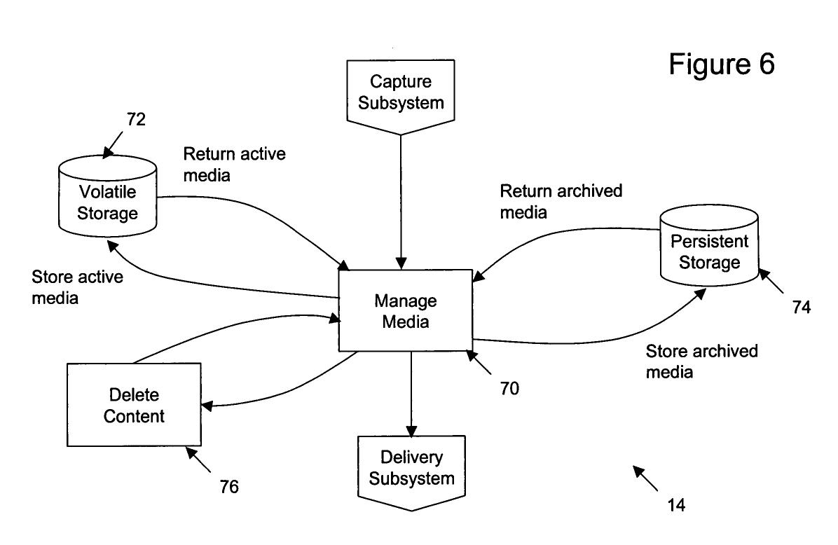

Returning to FIG. 6, the multimedia storage subsystem 14 will store any multimedia programming received from the multimedia delivery subsystem 16 for a configured period of time, usually days or weeks. After this time, the cached multimedia programming is discarded. The multimedia storage subsystem 14 (or subsystems, as clearly multiple subsystems could also be used) will also send any cached multimedia programming back to the multimedia delivery subsystem on request.

As shown in FIG. 6, the manage media control software 70 manages and stores serialized media content and associated control information, caching it in appropriate data structures such as queues, tables or other buffering formats. A combination of transient and permanent storage may be used, for example, content may be stored simultaneously both in the transient storage 72 and permanent storage 74. Transient storage 72 is preferably implemented using solid-state random access memory to provide fast access for the most commonly viewed segments of the recorded material for the most requested television channels. Archiving or permanent storage 74 is preferably implemented using movable magnetic media to hold a copy of all the recorded material for the engineered caching period. The manage media routine 70 periodically performs housekeeping tasks, for example, to discard aged or unused content 76.

As shown in FIG. 7, channel change requests are first processed by the management subsystem 32 by applying policy restrictions. Once processed, a channel change request 80 is sent to the delivery subsystem 16 whereby the delivery subsystem determines whether a channel change is required 82. Once the channel is selected 84, the delivery subsystem 16 selects the media 90 corresponding to the requested time index 86 and delivers it to the viewer as requested 92, changing the time index as required 88.

### ADVANTAGES

Thus, the invention provides many advantages over the existing products and services available. In particular,
it removes the need for a VCR or PVR-like device in the viewer premises, replacing it with a solid-state set-top box with very simple functionality. The set-top box of the invention is less expensive and far less likely to fail then VCRs and PVRs. As noted above, VCRs and PVRs are difficult to program, more likely to fail than the simple set-top box of the invention, can run out of tape or disk space and are subjected to the vagaries of the local electrical power utility. The method and system of the invention has none of these problems;
the invention is basically a centralized system which can offer much greater reliability in a cost effective way, incorporating necessary redundancy, service monitoring, etc. Overall costs are lower than alternative systems with less functionality;
viewers will not miss broadcasted programs with the invention. There is no need to race home to watch a show or worry about forgetting to set the VCR to record something;
there is no risk of the end of show being missed, which occurs with VCRs and PVRs which are programmed to record precise period of time. With the invention, the entire show is cached;
the invention is well suited to “channel surfing” as it permits the viewer to go back to the beginning of programs without having to tape the program; the interface of the invention allows easy access and review of multimedia programming recorded over many days for a large number of channels; and
policy enforcement is integrated into the system, making it easy to control access, for example, keeping children from viewing adult content and/or watching TV when they should be doing home work or sleeping.
   The embodiments of the invention provide all of these advantages, and do so without changing the way people interact with their TV.

OPTIONS AND ALTERNATIVESThe present invention has been described with regard to one or more embodiments. However, it will be apparent to persons skilled in the art that a number of variations and modifications can be made without departing from the scope of the invention as defined in the claims.

For example, additional functionality may easily be added to the invention, such as:

1) tracking the last time instance the viewer watched a given channel, by recording a last-seen marker consisting of both an absolute clock reference and/or a relative clock reference of the last time instance the viewer watched a given recorded channel. When the viewer wishes to re-select the channel, the multimedia programming is requested based on the last-seen marker recorded earlier;

2) the temporal indices of captured multimedia content may be coarse-grained or fine-grained such as seconds or minutes;

3) the symbolic or physical control buttons that permit absolute movements through the recorded material, may be in major time increments such as minutes or tens of minutes or to jump to fixed time indices such as HH:00 or HH:30, with a single action of the aforementioned control buttons; and

4) using in-band signaling to effect channel changing is not desirable, but could be used. Trying to carry channel change requests on the same protocol (typically RTSP for streaming media) requires the RTSP protocol be extended, and more importantly it ties the channel selection process, which has a policy component (subscriptions, permission, restrictions) with the mechanics of moving around a given channel. Thus, out-of-band communication is preferable.

What is claimed is:

1. A method for improving multimedia programming comprising steps of:
continuously capturing content data from a plurality of serialized multimedia sources in a central location;
compressing and storing said captured content data in at least one cache in a central location;
allowing a remote viewer to make selections with regard to the content and the manner in which the compressed and stored content data is to be transmitted to said viewer, including time and location;
validating and authorizing viewer access, channel and time indexing selection; and
delivering the selected content data to said viewer, over a bi-directional data network of appropriate bandwidth.

2. The method of claim 1 wherein said step of validating and authorizing comprises the steps of:
providing an access policy based on viewer preference and commercial relationship;
authorizing the viewer through an authentication mechanism in accordance with said access policy;
evaluating the viewer request for a stored serialized multimedia source against said access policy;
responding to a request for a serialized media source at a given time index by delivering multimedia programming according to:
a. multimedia programming associated with the requested time index, or,
b. the oldest cached multimedia programming available, if the requested time index is no longer available from the central cache.

3. The method of claim 1 wherein the step of continuously capturing comprises the step of simultaneously inserting time indices into said captured content data.

4. The method of claim 3 wherein said time indices are based on wall clock time.

5. The method of claim 4 wherein said time indices comprise a wall clock time stamp and a reference to a synchronization point in a recorded channel.

6. The method of claim 5 wherein said time indices comprise a reference frame associated with a modern video processing algorithm such as H.264.

7. The method of claim 3 wherein the step of continuously capturing comprises the step of pairing each serialized multimedia source with a separate processing engine to continuously process, and optionally compress, a show being captured on a channel, and the associated time indices in parallel to be stored.

8. The method of claim 7 wherein said time indices are discontiguous to allow for gaps in the source media delivery schedule, and are created simultaneously with show compression by a compression engine.

9. The method of claim 3 further comprising the steps of:
tracking the last time instance the viewer watched a given channel, by recording a last-seen marker consisting of both an absolute clock reference and/or a relative clock reference of the last time instance the viewer watched a given recorded media source by the client application; and
responding to the viewer re-selecting the channel, multimedia programming is requested based on the last-seen marker recorded earlier.

10. The method of claim 7 wherein the serialized media sources and associated control information are cached using transient and permanent storage and an appropriate data structure such as a queue, a table or other buffering format.

11. A system for improving television viewing comprising:
a media capture subsystem for continuously capturing content data from a plurality of serialized multimedia sources;
a subsystem for compressing and storing said captured content data in at least one central cache;
a subsystem allowing a remote viewer to make selections with regard to the content and the manner in which the compressed and stored content data is to be transmitted to said viewer, including time and location;
a multimedia delivery subsystem for delivering the selected content data to said viewer, over a bi-directional data network of appropriate bandwidth; and
a management sub-system for client validation, service verification, channel and time indexing selection, and system maintenance and administration functionality.

12. The system of claim 11 further comprising:
a management subsystem for client validation & authorization, service verification, policy enforcement and system maintenance and administration functionality.

13. The system of claim 11 further comprising:
a distributed control subsystem based on a wall clock time and relative time indices to permit the viewer to traverse and view the captured multimedia programming subjected to approval by the aforementioned management subsystem.

14. The system of claim 12 wherein said media capture system comprises a plurality of multimedia processing modules each capturing and processing one or more serialized media sources such as television channels in real time and simultaneously building fine-grained temporal indices into the processed multimedia programming for each channel.

15. The system of claim 14 wherein said multimedia processing modules further comprise one or more pairings of source capture capability such as television tuner/demultiplexer and corresponding audio and video signal encoder to digitize or transcode, optionally compress, and build fine-grained temporal indices of captured media source(s), supporting discontiguous time indices to permit for interruption in the delivery schedule of the serialized media sources.

16. The system of claim 15 wherein said fine-grained temporal indices are a stream of time indices consisting of the wall clock time and synchronization markers in the processed multimedia programming, such reference frames, well known to those familiar with the art.

17. The system of claim 12, wherein said management subsystem further comprises control logic to validate client request with respect to client authentication, access authorization based on client profile and pre-established access policy such as channel, time or location-based restrictions.

18. The system of claim 12, wherein said distributed control subsystem further comprises centrally located per multimedia source metadata such as fine-grained temporal index and viewer control subsystem appropriate to the display device to traverse and display the recorded multimedia sources.

19. The system of claim 18, wherein said control subsystem further comprises symbolic or physical control buttons allowing the viewer to view and traverse the recorded material using a graphical clock display of the current temporal index.

20. The system of claim 18, wherein said graphical display comprises an end device generated analog clock face displaying the current clock time index of the recorded material being viewed.

21. The system of claim 18, wherein said graphical display comprises an end device generated digital clock face displaying the current clock time index of the recorded material being viewed.

22. The system of claim 19 further comprising symbolic or physical control buttons that permit a tailored traversal of the recorded material, the degree of traversal being set to fine-grained or coarse-grained temporal increments such as seconds or minutes.

23. The system of claim 19 further comprising symbolic or physical control buttons that permits absolute movements through the recorded material in major time increments such as minutes or tens of minutes or to jump to fixed time indices such as HH:00 or HH:30, with single action of the aforementioned control buttons.

24. The method of claim 20 further comprising the fine-grained synchronization of the graphical analog clock display with the current temporal index of the recorded material being viewed and the action of the aforementioned control buttons.

25. The method of claim 21 further comprising the fine-grained synchronization of the graphical digital clock display with the current temporal index of the recorded material being viewed and the action of the aforementioned control buttons.

26. The storage subsystem of claim 12 further comprising a combination of transient and permanent storage wherein the processed television programming received from the aforementioned capture subsystem is stored simultaneously both in the transient and permanent storage.

27. The storage subsystem of claim 26 wherein the transient storage is used to provide fast access for the most commonly viewed segments of the recorded material for the most requested television channels and the permanent storage is used to hold a copy of all the recorded material for the engineered caching period.

28. The storage subsystem of claim 26 wherein solid-state random access memory is used for transient storage and movable magnetic media is used for permanent storage.
